(19) United States
(12) Patent Application Publication
(10) Pub. No.: US 2015/0252589 A1
(43) Pub. Date: Sep. 10, 2015

(54) Deadbolt Reinforcement Bracket Device

(71) Applicant: Bill A. Johnson, Oklahoma City, OK (US)

(72) Inventor: Bill A. Johnson, Oklahoma City, OK (US)

(21) Appl. No.: 14/196,070

(22) Filed: Mar. 4, 2014

(51) Int. Cl. E05B 15/02

(52) U.S. Cl. CPC E05B 15/0205

(57) ABSTRACT

A deadbolt reinforcement bracket device secures a deadbolt and door jamb to a structural frame surrounding a doorway. The device includes a bracket having a plurality of holes extending therethrough. A first section of the bracket is couplable to a structural frame and a second section of the bracket is couplable to a door jamb. A receiver is coupled to and extends from the bracket. The receiver is fixedly positioned relative to the bracket and has an aperture extending therethrough to receive a deadbolt wherein the receiver inhibits lateral movement of the deadbolt relative to the bracket.

### BACKGROUND OF THE DISCLOSURE

1. Field of the Disclosure

The disclosure relates to bracket devices and more particularly pertains to a new bracket device for securing a deadbolt and door jamb to a structural frame surrounding a doorway.

2. Summary of the Disclosure

An embodiment of the disclosure meets the needs presented above by generally comprising a bracket having a plurality of holes extending therethrough. A first section of the bracket is couplable to a structural frame and a second section of the bracket is couplable to a door jamb. A receiver is coupled to and extends from the bracket. The receiver is fixedly positioned relative to the bracket and has an aperture extending therethrough to receive a deadbolt wherein the receiver inhibits lateral movement of the deadbolt relative to the bracket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a deadbolt reinforcement bracket device according to an embodiment of the disclosure.

FIG. 2 is a top front side perspective view of an embodiment of the disclosure.

FIG. 3 is a front view of an embodiment of the disclosure.

FIG. 4 is a top view of an embodiment of the disclosure when installed.

### DESCRIPTION OF THE PREFERRED EMBODIMENT

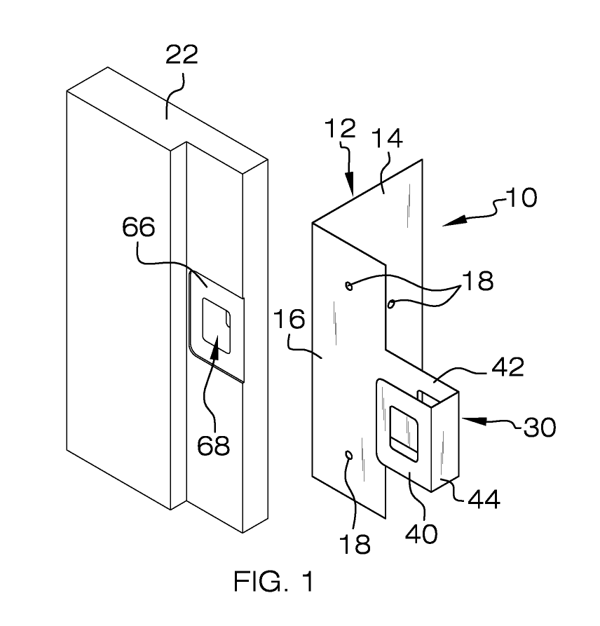

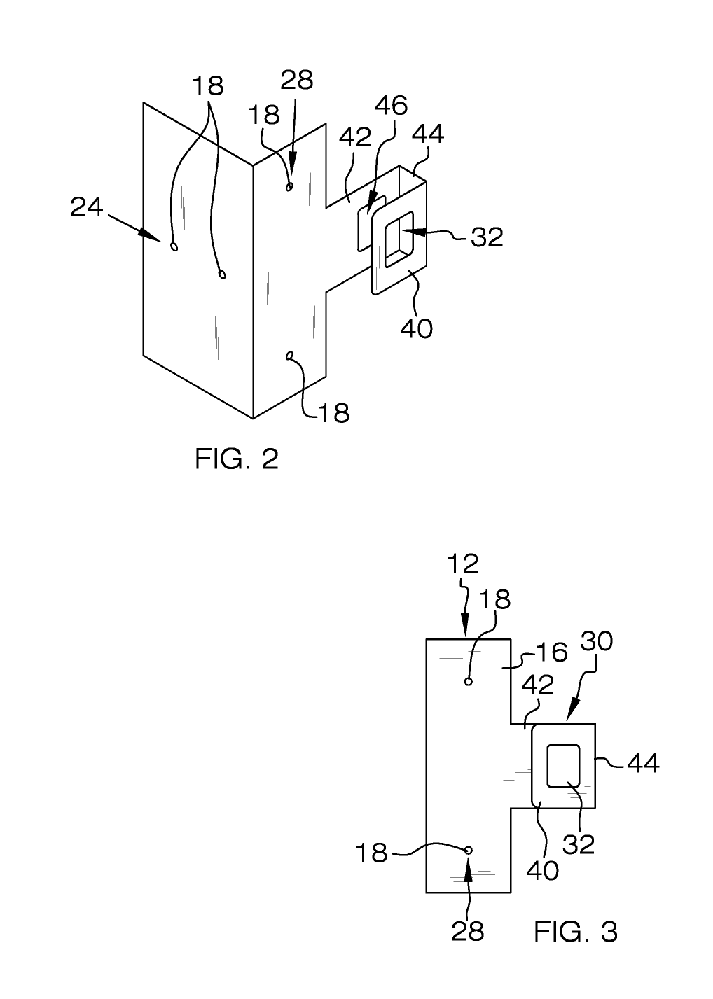

With reference now to the drawings, and in particular to FIGS. 1 through 4 thereof, a new bracket device embodying the principles and concepts of an embodiment of the disclosure and generally designated by the reference numeral 10 will be described.

As best illustrated in FIGS. 1 through 4, the deadbolt reinforcement bracket device 10 generally comprises a bracket 12 having a first section 14 and a second section 16. The bracket 12 has a plurality of holes 18 extending therethrough such that the first section 14 of the bracket 12 is configured for coupling to a structural frame 20 and the second section 16 of the bracket 12 is configured for coupling to a door jamb 22. The holes 18 include a first pair 24 of holes 18 extending through the first section 14 of the bracket 12. The first pair 24 of holes 18 are horizontally aligned when the bracket 12 is installed. The first pair 24 of holes 18 are laterally spaced such that each hole 18 of the first pair 24 aligns with an associated one of a pair of boards 26 joined to form a door opening in the structural frame 20 as is typically provided in framing of buildings. The holes 18 include a second pair 28 of holes 18 extending through the second section 16 of the bracket 12. The second pair 28 of holes 18 are vertically aligned. Each of the first section 14 and the second section 16 is planar. The second section 16 extends transversely from the first section 14 wherein the bracket 12 is substantially L-shaped to position the door jamb 22 in proper alignment with the structural frame 20.

A receiver 30 is coupled to and extends from the bracket 12. The receiver 30 is fixedly positioned relative to the bracket 12 to transfer forces on the receiver 30 to the bracket 12. The receiver 30 has an aperture 32 extending therethrough wherein the receiver 30 is configured for receiving a deadbolt 36 through the aperture 32 wherein the receiver 30 inhibits lateral movement of the deadbolt 36 relative to the bracket 12. Thus, the receiver 30 strengthens resistance to forcibly opening a door 38 from which the deadbolt 36 extends. The device 10 secures the deadbolt 36 relative to the structural frame 20 as well as enhancing coupling of the door jamb 20 to the structural frame 20. The receiver 30 comprises a pair of parallel outer sections 40,42 and a medial section 44 coupled to and extending between the outer sections 40,42 wherein the receiver 30 is substantially U-shaped. A first one of the outer sections 40 is positioned in parallel spaced relationship to the second section 16 of the bracket 12. The first one of the outer sections 40 may be positioned in a cutout 66 in the door jamb 22. The aperture 32 is a first aperture 32 extending through the first one of the outer sections 40 of the receiver 30 and aligning with a cavity 68 extending into the door jamb 22. A second aperture 46 may extend through a second one of the outer sections 42 of the receiver 30. The second aperture 46 is aligned with the first aperture 32 allowing for further extension of the deadbolt 36 through both outer sections 40,42 and into a cavity extending into the structural frame 20 if so desired. The second one of the outer sections 42 of the receiver 30 is coplanar with the second section 16 of the bracket 12. The second one of the outer sections 42 of the receiver 30 may be an integral extension of the second section 16 of the bracket 12. In fact, the bracket 12 and the receiver 30 may be formed from a bent single sheet of material 48 such as sheet metal or the like. The device 10 may be provided with a sheet thickness between 10 and 40 millimeters.

In use, the bracket 12 is attached to the door jamb 22 using conventional fasteners such as screws 58. The bracket 12 is then secured to the structural frame 20 as shown in

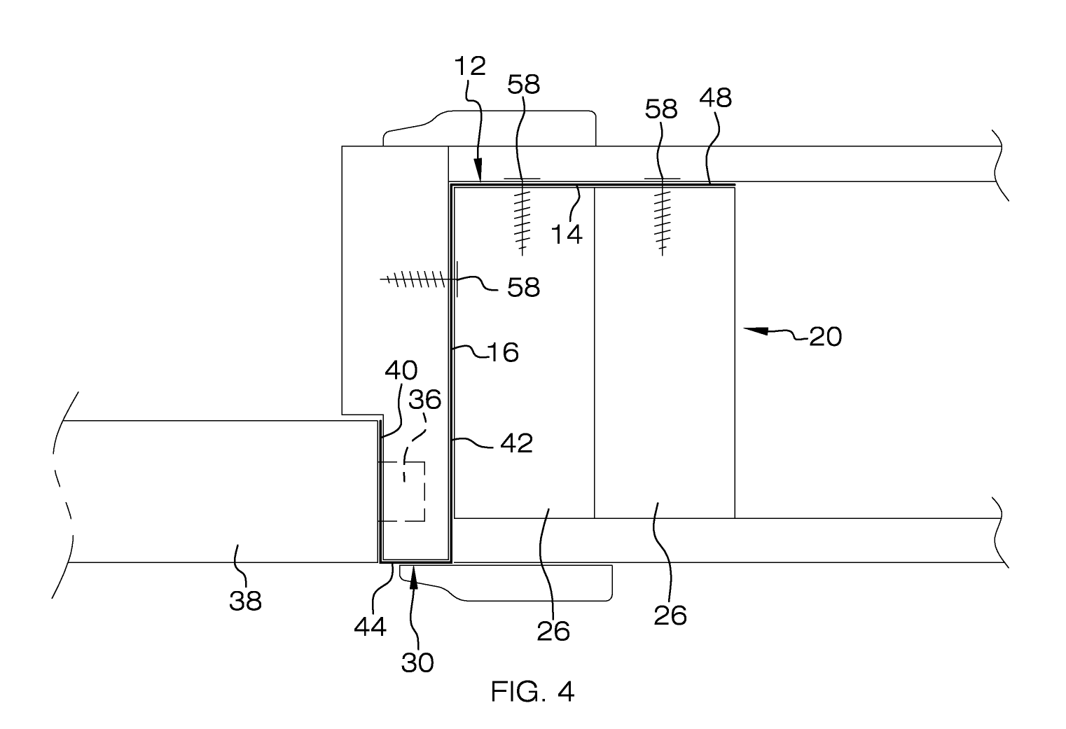

FIG. 4. Drywall, sheetrock, and/or other conventional framing and trim may then be installed in a conventional manner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A deadbolt reinforcement bracket device comprising:
a bracket having a first section and a second section, said bracket having a plurality of holes extending therethrough wherein said first section of said bracket is configured for coupling to a structural frame and said second section of said bracket is configured for coupling to a door jamb; and
a receiver coupled to and extending from said bracket, said receiver being fixedly positioned relative to said bracket, said receiver having an aperture extending therethrough wherein said receiver is configured for receiving a deadbolt through said aperture wherein said receiver inhibits lateral movement of the deadbolt relative to said bracket.

2. The device of claim 1, further comprising each of said first and second sections being planar, said second section extending transversely from said first planar section wherein said bracket is substantially L-shaped.

3. The device of claim 1, further comprising said holes including a first pair of holes, said first pair of holes extending through said first section of said bracket.

4. The device of claim 3, further comprising said holes including a second pair of holes, said second pair of holes extending through said second section of said bracket.

5. The device of claim 1, further comprising said receiver comprising a pair of parallel outer sections and a medial section coupled to and extending between said outer sections wherein said receiver is substantially U-shaped.

6. The device of claim 5, further comprising a first one of said outer sections of said receiver being positioned in parallel spaced relationship to said second section of said bracket.

7. The device of claim 6, further comprising said aperture being a first aperture extending through said first one of said outer sections of said receiver.

8. The device of claim 7, further comprising a second aperture extending through a second one of said outer sections of said receiver, said second aperture being aligned with said first aperture.

9. The device of claim 6, further comprising a second one of said outer sections of said receiver being coplanar with said second section of said bracket.

10. The device of claim 9, further comprising said second one of said outer sections of said receiver being an integral extension of said second section of said bracket.

11. The device of claim 10, further comprising said bracket and said receiver being formed from a bent single sheet of material.

12. A deadbolt reinforcement bracket device comprising:
a bracket having a first section and a second section, said bracket having a plurality of holes extending therethrough wherein said first section of said bracket is configured for coupling to a structural frame and said second section of said bracket is configured for coupling to a door jamb, said holes including a first pair of holes, said first pair of holes extending through said first section of said bracket, said holes including a second pair of holes, said second pair of holes extending through said second section of said bracket, each of said first and second sections being planar, said second section extending transversely from said first planar section wherein said bracket is substantially L-shaped;
a receiver coupled to and extending from said bracket, said receiver being fixedly positioned relative to said bracket, said receiver having an aperture extending therethrough wherein said receiver is configured for receiving a deadbolt through said aperture wherein said receiver inhibits lateral movement of the deadbolt relative to said bracket, said receiver comprising a pair of parallel outer sections and a medial section coupled to and extending between said outer sections wherein said receiver is substantially U-shaped;
a first one of said outer sections of said receiver being positioned in parallel spaced relationship to said second section of said bracket, said first aperture extending through said first one of said outer sections of said receiver; and
a second aperture extending through a second one of said outer sections of said receiver, said second aperture being aligned with said first aperture, said second one of said outer sections of said receiver being coplanar with said second section of said bracket, said second one of said outer sections of said receiver being an integral extension of said second section of said bracket, said bracket and said receiver being formed from a bent single sheet of material.
